(19) United States
(12) Patent Application Publication
(10) Pub. No.: US 2021/0302731 A1
(43) Pub. Date: Sep. 30, 2021

(54) LASER-BASED WAVEGUIDED ILLUMINATION FOR FRONT-LIT LIQUID CRYSTAL ON SILICON DISPLAY

(71) Applicant: LUMINIT LLC, TORRANCE, CA (US)

(72) Inventor: FEDOR DIMOV, TORRANCE, CA (US)

(21) Appl. No.: 16/835,630

(22) Filed: Mar. 31, 2020

(51) Int. Cl. G02B 27/01; H04N 9/31

(52) U.S. Cl. CPC G02B 27/0103; H04N 9/3105; G02B 2027/0174; G02B 27/0172; G02B 2027/0105; H04N 9/3161

(57) ABSTRACT

This application is directed to a compact, lightweight, low power, front-lit monochrome or full-color LCOS display assembly featuring a volume substrate-guided hologram (SGH) optic based on thin and transparent holographic components (THC) with laser-based illumination.

### TECHNICAL FIELD

This application is directed to a compact, lightweight, low power consumption, front-lit monochrome or full-color front-lit liquid crystal on silicon (LCOS) spatial light modulator or display module for near to eye display (NTED), heads-up display (HUD), and Head-Mounted Display (HMD) applications featuring a volume substrate-guided hologram (SGH) optic based on thin and transparent holographic components (THC) with laser-based illumination.

### BACKGROUND

It is estimated that the combined revenues for sales of augmented reality (AR), virtual reality (VR), and smart glasses will approach $80 billion by the year 2025. About half of that revenue is directly proportional to the hardware of the devices, including the optics. However, despite this huge demand, such devices remain difficult to manufacture and the quality is lacking. One reason is that traditional optical elements are limited to the laws of refraction and reflection, which require cumbersome custom optical elements that are difficult to fabricate to form a usable image in the wearer's visual field. Another reason is that the refractive optical materials are heavy in weight. Still another reason is that existing devices offer a narrow field of view. An additional reason is that recent designs based on diffractive or holographic optics have significant color dispersion, crosstalk, and degradation. Yet another reason is that present-day holographic and diffractive designs have low diffraction efficiency (DE) and the luminance of the virtual image is low. These limitations result in devices that are less than satisfactory.

Thus, there exists a need for an effective solution to the problem of the inability to manufacture and provide a quality microdisplay assembly for laser-based NTED and HMD, which the present disclosure addresses.

### BRIEF SUMMARY

The present application is directed to a microdisplay assembly comprising (a) a single volume thick hologram based on thin and transparent holographic components (THC) wherein the hologram is angle selective; (b) a transparent substrate comprising a thickness of about 1-3 mm wherein the hologram is attached to an upper surface of the substrate; (c) a light source comprising a laser or a narrow band light wherein the light source is attached to or near a side surface of the substrate; and (d) a reflective-type spatial light modulator with color filters wherein the spatial light modulator is attached to a lower surface of the substrate.

In one embodiment, at least one side of the substrate comprises an anti-reflective coating. In another embodiment, the substrate comprises a single plate or multiple plates. In a second embodiment, the spatial light modulator comprises a LCOS microdisplay. In another embodiment, the spatial light modulator is directly attached to the substrate or comprises a gap relative to the substrate. In another embodiment, the substrate comprises a shape matching the shape of the spatial light modulator. In another embodiment, the LCOS microdisplay comprises color filters.

In still another embodiment, the microdisplay assembly further comprises a thin glass wedge located at a top surface of the hologram wherein an air gap exists between the hologram and the glass wedge. In another embodiment, the substrate comprises a unitary body or a plurality of bodies made of the same material or different materials.

In still another embodiment, one or more edges of the substrate comprise a light absorptive coating.

In yet another embodiment, the angular selectivity of the hologram comprises at least 2° angle wherein a diffracted beam reflected from the spatial light modulator is not in Bragg with the hologram to diffract back in the substrate. In still another embodiment, the hologram recording parameters are adjusted to reduce sidelobes in a diffractive order and wherein playback wavelengths are adjusted to center a diffractive order. In another embodiment, the efficiency of the diffracted beam becomes zero when a playback beam perpendicular to the hologram deviates about 2° from a Bragg condition.

In one embodiment, the hologram transmits diffracted beams forward thereby illuminating the spatial light modulator and wherein beams reflected from the spatial light modulator are not in Bragg with the hologram as diffracted beams. In another embodiment, the hologram comprises angular and wavelength selectivities to avoid crosstalk of colors.

In still another embodiment, an initial beam passes through the substrate to the hologram and travels through the hologram as a guided beam wherein the guided beam is diffracted by the hologram back through the substrate to an upper surface of the spatial light modulator, which reflects the beam up through the substrate and through the hologram then out to a viewer.

In yet another embodiment, the microdisplay assembly is a monochrome or an RGB (full color) microdisplay. The retrieved image comprises a monochrome or an RGB (full color) image. The microdisplay assembly functions as the hologram first diffracts an expanded guided laser beam to illuminate the spatial light modulator, then a reflected beam passes through the hologram and couples out without diffraction counterpropagating the guided beam. In another embodiment, the microdisplay assembly has field-of-view of at least 30°.

The microdisplay assembly of this application has several benefits and advantages. One benefit is the very high luminance of the virtual image. A second benefit is the increase in uniformity of the image created by the hologram, particularly the red beam. Another advantage is that the HMD is small, low profile, and lightweight, due to the LCOS front-lit microdisplay assembly. Yet another advantage is that by having only one hologram in the assembly, the diffraction efficiency (DE) is increased up to 8-fold. An additional advantage is that the color change across the FOV is eliminated. Another advantage is that there is less dispersion, resulting in a very crisp, bright image.

### BRIEF DESCRIPTION OF THE DRAWINGS

FIG. 1 is an illustration of one embodiment of the structure of the laser-based waveguided illumination for the front-lit LCOS using SGH.

FIG. 2 is an illustration of the recording beam angles that facilitate illuminating the LCOS microdisplay at playback efficiently with avoidance of the reflected beam from LCOS to be in Bragg with the hologram.

FIG. 3 illustrates the color mixing box for red, green and blue laser wavelengths.

FIG. 4 is an illustration of one embodiment of the structure of the laser-based waveguide with front-lit LCOS illuminated with red, green and blue laser diodes through the edge using SGH.

FIG. 5 illustrates examples of RGB SGH illuminated through an edge by the guided red, green, and blue beams, as well as by the combined RGB beam.

### DETAILED DESCRIPTION OF EXEMPLARY EMBODIMENTS

The present application relates to a microdisplay assembly having a volume (thick) substrate-guided hologram (SGH) based on transparent holographic components (THC) with a front-lit spatial light modulator.

More specifically, this application is directed to a microdisplay assembly comprising (a) a single volume thick hologram based on thin and transparent holographic components (THC) wherein the hologram is angle selective; (b) a transparent substrate comprising a thickness of about 1-3 mm wherein the hologram is attached to an upper surface of the substrate; (c) a light source comprising a laser or a narrow band light wherein the light source is attached to or near a side surface of the substrate; and (d) a reflective-type spatial light modulator wherein the spatial light modulator is attached to a lower surface of the substrate.

FIG. 1 illustrates an example of a microdisplay assembly 10 having a single volume thick hologram (SGH) 12 based on THC components wherein the hologram 12 is angle selective. The angular selectivity of the hologram 12 comprises at least a 2° angle wherein a diffracted beam reflected from the spatial light modulator 16 is not in Bragg with the hologram 12 to diffract back in the substrate 14. The hologram 12 has angular and wavelength selectivities to avoid crosstalk of colors. A measure of hologram selectivity is the halfwidth of spectral and angular selectivity contours. The wavelength selectivity can be roughly estimated by Δλ/λ≈Λ/d, where λ is the vacuum wavelength of the reading light, Λ is the period length of the grating and d is the thickness of the hologram; for the typical holograms used in visible light at λ=500 nm with typical grating period Λ<1 um and general hologram thickness 20 um Δλ<25 nm. The angular selectivity Δθ can be estimated as well: Δθ≈Λ/d, where d is the thickness of the holographic grating. Using the typical values Λ<1 um, d=20 um, the results are Δθ≈0.04 rad≈2°. The hologram recording parameters are adjusted to reduce sidelobes in a diffractive order and wherein playback wavelengths are adjusted to the peak wavelength of the DE.

The substrate 14 is entirely transparent to provide wide see-through FOV and can be made from a number of materials, such as glass, quartz, acrylic plastic, polycarbonate plastic, or a mixture thereof. The substrate 14 can be a single plate or multiple plates of the same or different materials and can have a variety of shapes. The shape of the substrate 14 should match the shape of the spatial light modulator 16. One side of the substrate 14 can be anti-reflective (AR) coated to improve the see-through transmission. The thickness of the substrate 14 can be in the range of about 1-3 mm. The substrate 14 can be made of a single unitary body or can comprise a plurality of bodies made of the same or different transparent materials. Some edges of the substrate 14 can also be coated with a light absorptive coating, such as a black paint.

The spatial light modulator 16 is a laser-illuminated front-lit LCOS. The spatial light modulator 16 can be directly attached to the substrate 14 or there can be a gap between the spatial light modulator 16 and the substrate 14. Each pixel of the spatial light modulator 16 comprises 3 color filters—red, green and blue.

A laser 18 can be directly attached to the substrate 14 or there can be a gap between the laser 18 and the substrate 14.

The microdisplay assembly 10 can be a full-color (RGB) or monochrome assembly and can have a field-of-view of at least 30°. The microdisplay assembly 10 functions by having an initial beam (a) passing through the substrate 14 to the hologram 12 and travels through the hologram 12 as a guided beam wherein the guided beam (b) is diffracted by the hologram 12 back through the substrate 14 to an upper surface of the spatial light modulator 16, which reflects the beam up (c) through the substrate 14 and through the hologram 12 then out to a viewer. In other words, in operation, the hologram 12 first diffracts an expanded guided laser beam to illuminate the spatial light modulator 16, then a reflected beam passes through the hologram 12 and couples out without diffraction counterpropagating the guided beam. The microdisplay assembly 10 can further comprise a thin glass wedge 20 located at a top surface of the hologram 12 wherein an air gap exists between the hologram 12 and the glass wedge 20. The microdisplay assembly 10 functions as to the hologram 12 transmitting diffracted beams forward thereby illuminating the spatial light modulator 16 and wherein beams reflected from the spatial light modulator 16 are not in Bragg with the hologram 12 as diffracted beams. The efficiency of the diffracted beam reduces more than 50% when a playback beam perpendicular to the hologram 12 deviates about 2° angle from a Bragg condition.

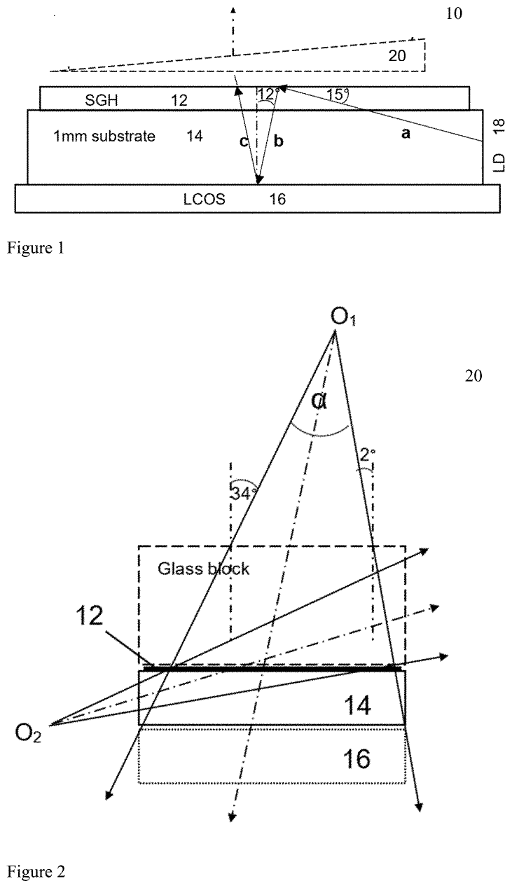

FIG. 2 illustrates an example of a recording system 20 of a reflection RGB SGH 12 recorded with two spherical divergent beams with recording points O₁ and O₂. This recording system is specifically designed to record the SGH 12, which, at playback, should efficiently and uniformly illuminate the LCOS microdisplay 16 and provide high luminance for the retrieved HMD high luminance virtual image. This recording system also creates the beam angles that don't have crosstalk between diffracted and reflected from LCOS beams. One recording RGB beam in this system is divergent from point O₁. Another RGB beam is divergent from point O₂. When the beam from point O₂ enters the substrate 14, it becomes guided. Both beams should cover the recorded SGH 12, which is laminated to a 1 mm glass substrate 14, and then is index-matched to a glass block 22 shown with dashed rectangle that is needed to avoid recording beam coming from point O₂, experiencing total internal reflection, TIR, reflecting back in holographic polymer and recording unwanted transmission SGH. In order to experience TIR and become guided, the recording beam can have angles with the glass substrate 14 surface with the laminated holographic polymer therein not larger than 48°, because the TIR angle for the border between air and glass is about 42° and can be calculated using Snell's law. The minimal angle with the glass substrate 14 surface with the laminated holographic polymer should not be very small (>12°) because even tiny differences in the refractive index between the glass and the holographic polymer will make propagating of the shallow guided beam problematic, especially considering that the refractive indices of the holographic material are slightly different before and after recording (Δn˜0.03). The guided beams should propagate reliably during both recording and playback. The reliable guided angles should be >12° for the holographic material that is used with the average refractive index n˜1.48. In this example, the minimal and maximal angles in the medium of the coming from point O₂ divergent beam are 13° and 25° respectively. The angle α of the divergent beam coming from point O₁ is chosen to illuminate the area equal to the entire LCOS microdisplay 16 shown in FIG. 2 with dotted rectangle (it is not there during SGH recording), create the required FOV of the microdisplay at playback that should be not less than 30°.

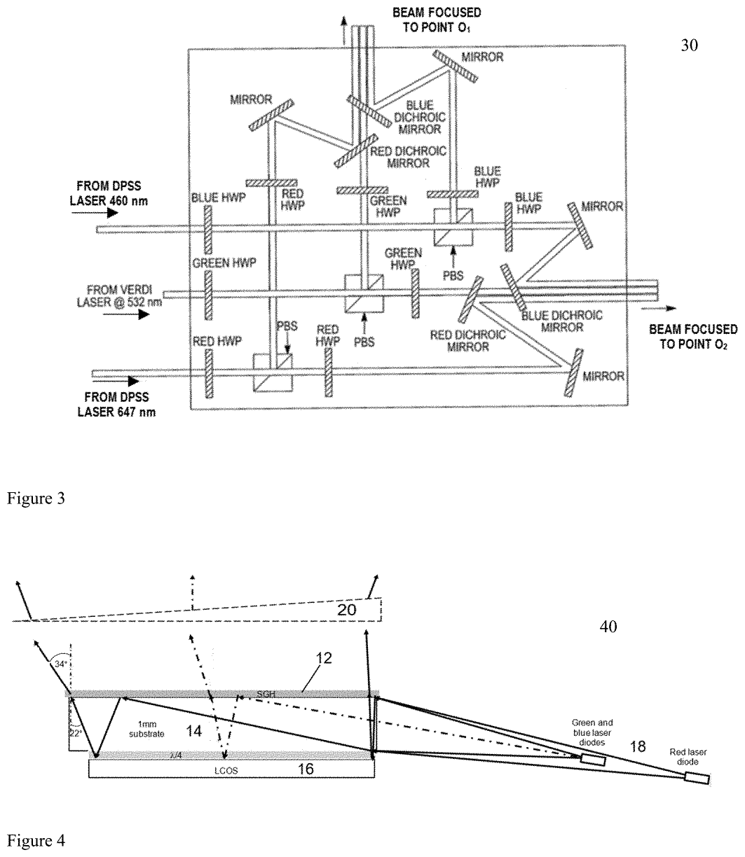

FIG. 3 illustrates the color mixing box to create two RGB laser beams for hologram recording. This color mixing box is used for the RGB holograms recording. After recording and processing of this SGH, it is played back, as shown in FIG. 4.

In FIG. 4, the recorded RGB SGH 12 is illuminated through an edge by the guided red, green, and blue beams as well as by the combined RGB beam. These beams are created by the red, green, and blue laser diodes (LD) 18. The wavelengths and divergencies of these LD beams and their position and distance from the 1 mm substrate 14 should be chosen to be in Bragg with recorded as shown in FIG. 2 SGH 12. The number of the LD for each color maybe more than one if one LD won't cover the entire LCOS after diffraction on the recorded SGH 12. Accordingly, the number of recorded SGH 12 should be more than one, and that two or more SGH 12 should be shift-multiplexed to cover entire LCOS 16 microdisplay. The SGH 12 beams after reflecting from the LCOS back to the SGH 12 shouldn't diffract on the SGH 12 again and directed back in the 1 mm substrate 14 as guided beam. This condition imposes limitation on the divergency of the diffracted beam. In FIG. 4 are shown the angles of diffracted and coupled out beam that are not in Bragg with recorded SGH 12 as shown in FIG. 2.

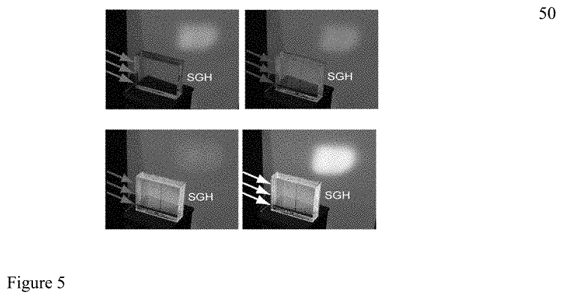

FIG. 5 illustrates examples of RGB SGH illuminated through an edge by the guided red, green, and blue beams, as well as by the combined RGB beam.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. A microdisplay assembly comprising:
(a) a single volume thick hologram based on thin and transparent holographic components (THC) wherein the hologram is angle selective;
(b) a transparent substrate comprising a thickness of about 1-3 mm wherein the hologram is attached to an upper surface of the substrate;
(c) a light source comprising a laser or a narrow band light wherein the light source is attached to or near a side surface of the substrate; and
(d) a reflective-type spatial light modulator wherein the spatial light modulator is attached to a lower surface of the substrate.

2. The microdisplay assembly of claim 1 wherein at least one side of the substrate comprises an anti-reflective coating.

3. The microdisplay assembly of claim 1 wherein the substrate comprises a single plate or multiple plates.

4. The microdisplay assembly of claim 1 wherein the angular selectivity of the hologram comprises at least a 2° angle wherein a diffracted beam reflected from the spatial light modulator is not in Bragg with the hologram to diffract back in the substrate.

5. The microdisplay assembly of claim 1 wherein hologram recording parameters are adjusted to reduce sidelobes in a diffractive order and wherein playback wavelengths are adjusted to center a diffractive order.

6. The microdisplay assembly of claim 1 wherein the hologram transmits diffracted beams forward thereby illuminating the spatial light modulator and wherein beams reflected from the spatial light modulator are not in Bragg with the hologram as diffracted beams.

7. The microdisplay assembly of claim 1 wherein the spatial light modulator comprises a liquid crystal on silicon (LCOS) microdisplay.

8. The microdisplay assembly of claim 1 further comprising a thin glass wedge located at a top surface of the hologram wherein an air gap exists between the hologram and the glass wedge.

9. The microdisplay assembly of claim 1 wherein the substrate comprises a unitary body or a plurality of bodies made of the same material or different materials.

10. The microdisplay assembly of claim 1 wherein one or more edges of the substrate comprise a light absorptive coating.

11. The microdisplay assembly of claim 1 wherein the spatial light modulator is directly attached to the substrate or comprises a gap relative to the substrate.

12. The microdisplay assembly of claim 1 wherein an initial beam passes through the substrate to the hologram and travels through the hologram as a guided beam wherein the guided beam is diffracted by the hologram back through the substrate to an upper surface of the spatial light modulator, which reflects the beam up through the substrate and through the hologram then out to a viewer.

13. The microdisplay assembly of claim 12 wherein an efficiency of the diffracted beam becomes zero when a playback beam perpendicular to the hologram deviates about 2° angle from a Bragg condition.

14. The microdisplay assembly of claim 1 wherein the substrate comprises a shape matching a shape of the spatial light modulator.

15. The microdisplay assembly of claim 1 comprising a monochrome or an RGB (full color) microdisplay.

16. The microdisplay assembly of claim 1 wherein a retrieved image comprises a monochrome or an RGB (full color) image.

17. The microdisplay assembly of claim 1 wherein the hologram first diffracts an expanded guided laser beam to illuminate the spatial light modulator, then a reflected beam passes through the hologram and couples out without diffraction counterpropagating the guided beam.

18. The microdisplay assembly of claim 1 wherein the LCOS microdisplay comprises color filters.

19. The microdisplay assembly of claim 1 wherein the hologram comprises angular and wavelength selectivities to avoid crosstalk of colors.

20. The microdisplay assembly of claim 1 comprising a field-of-view of at least 30°.
